(19) United States
(12) Patent Application Publication
(10) Pub. No.: US 2020/0351457 A1
(43) Pub. Date: Nov. 5, 2020

(54) OPTICAL SENSOR AND IMAGE SENSING METHOD

(71) Applicants: Egis Technology Inc., Taipei (TW); Igistec Co., Ltd., Hsinchu County (TW)

(72) Inventors: Chung-Yi Wang, Hsinchu County (TW); Yu-Hsuan Lin, Hsinchu County (TW)

(73) Assignees: Egis Technology Inc., Taipei (TW); Igistec Co., Ltd., Hsinchu County (TW)

(21) Appl. No.: 16/815,021

(22) Filed: Mar. 11, 2020

Related U.S. Application Data
(60) Provisional application No. 62/842,540, filed on May 3, 2019.

(30) Foreign Application Priority Data
Jan. 13, 2020 (CN) 202010030353.1

(51) Int. Cl. H04N 5/357

(52) U.S. Cl. CPC H04N 5/3575; G06K 9/00013; H04N 5/3577

(57) ABSTRACT

The invention provides an optical sensor and an image sensing method. The optical sensor includes a sensing array, a sampling circuit and an operational circuit. The sensing array performs an exposure operation to sense an object and output a plurality of first sensing signals, and performs a reset operation to output a plurality of second sensing signals. The sampling circuit outputs a plurality of first pixel data of an object image according to the plurality of first sensing signals, and outputs a plurality of second pixel data according to the plurality of second sensing signals. The operational circuit executes a subtraction operation on the plurality of first pixel data and the plurality of second pixel data to obtain a denoised object image. Therefore, the sampling circuit and the image sensing method of the invention can effectively obtain the denoised object image.

### CROSS-REFERENCE TO RELATED APPLICATION

This application claims the priority benefits of U.S. provisional application Ser. No. 62/842,540, filed on May 3, 2019, and China application serial no. 202010030353.1, filed on Jan. 13, 2020. The entirety of each of the above-mentioned patent applications is hereby incorporated by reference herein and made a part of this specification.

### BACKGROUND

### Technical Field

The disclosure relates to a sensing technology, and in particular, to an optical sensor and an image sensing method.

### Description of Related Art

In the processing of image sensing results suffering from noise interference by a traditional optical sensor, generally, after an object is sensed by the optical sensor, a relevant denoising image processing operation is performed on the image sensing results by a back-end operational circuit. In other words, the denoising of the traditional optical sensor requires additional operation resources and image processing time to obtain good object image quality. Besides, the interference to the optical sensor may change at any time, so the back-end operational circuit even needs a complicated operation design to be able to achieve effective denoising processing for the image sensing results at any time point. In view of this, in order to save operation resources and provide a real-time and fast denoising effect on the object image, solutions of several embodiments will be provided below.

### SUMMARY

The invention is directed to an optical sensor and an image sensing method that can effectively obtain a denoised object image.

According to an embodiment of the invention, the optical sensor of the invention includes a sensing array, a sampling circuit and an operational circuit. The sensing array performs an exposure operation to sense an object and output a plurality of first sensing signals, and performs a reset operation to output a plurality of second sensing signals. The sampling circuit is coupled to the sensing array. The sampling circuit outputs a plurality of first pixel data of an object image according to the plurality of first sensing signals, and outputs a plurality of second pixel data according to the plurality of second sensing signals. The operational circuit is coupled to the sampling circuit. The operational circuit executes a subtraction operation on the plurality of first pixel data and the plurality of second pixel data to obtain a denoised object image.

According to an embodiment of the invention, the image sensing method of the invention is adapted for an optical sensor. The optical sensor includes a sensing array, a sampling circuit, and an operational circuit. The image sensing method includes the following steps: performing an exposure operation by the sensing array to sense an object and output a plurality of first sensing signals, and performing a reset operation by the sensing array to output a plurality of second sensing signals; outputting a plurality of first pixel data of an object image by the sampling circuit according to the plurality of first sensing signals, and outputting a plurality of second pixel data according to the plurality of second sensing signals; and executing a subtraction operation on the plurality of first pixel data and the plurality of second pixel data by the operational circuit to obtain a denoised object image.

Based on the above, according to the optical sensor and the image sensing method of the invention, the pixel data having only background noise can be obtained during the reset process of the sensing unit of the optical sensor, and subtraction is performed on the pixel data having background noise and object image information obtained by the exposure of the sensing unit and the above pixel data having the background noise to obtain the denoised object image.

To make the features and advantages of the invention clear and easy to understand, the following gives a detailed description of embodiments with reference to accompanying drawings.

### BRIEF DESCRIPTION OF THE DRAWINGS

The accompanying drawings are included to provide a further understanding of the invention, and are incorporated in and constitute a part of this specification. The accompanying drawings are included to provide a further understanding of the invention, and are incorporated in and constitute a part of this specification.

FIG. 1 shows a schematic diagram of an optical sensor according to an embodiment of the invention.

FIG. 2 shows a schematic diagram of an object image and background noise according to an embodiment of the invention.

FIG. 3 shows a schematic diagram of an active pixel sensing unit according to an embodiment of the invention.

FIG. 4 shows a timing diagram of an exposure operation and a reset operation according to an embodiment of the invention.

FIG. 5 shows a schematic diagram of a passive pixel sensing unit according to an embodiment of the invention.

FIG. 6 shows a flow chart of an image sensing method according to an embodiment of the invention.

### DESCRIPTION OF THE EMBODIMENTS

Exemplary embodiments of the invention are described in detail, and examples of the exemplary embodiments are shown in the accompanying drawings. Whenever possible, the same component symbols are used in the drawings and descriptions to indicate the same or similar parts.

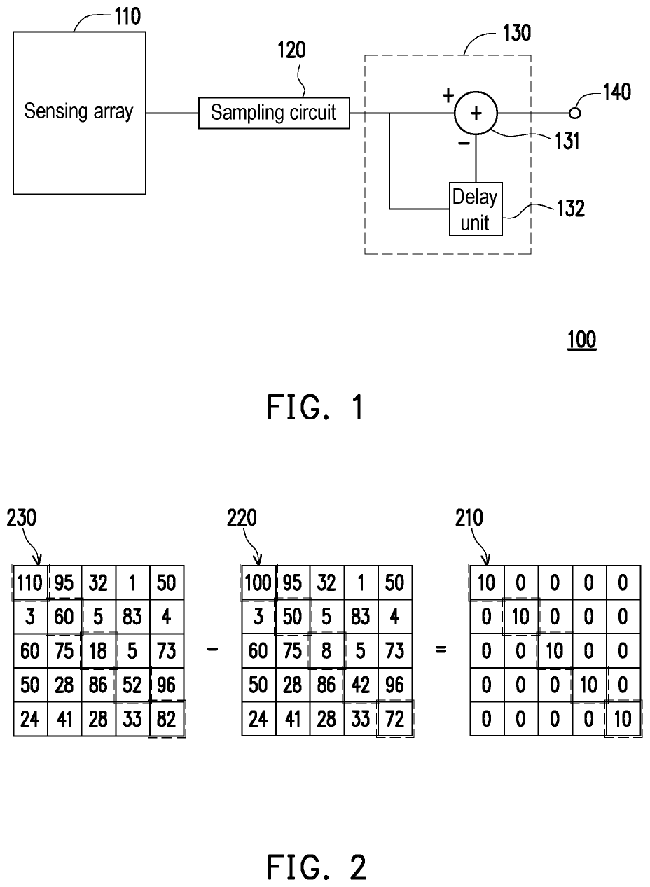

FIG. 1 shows a schematic diagram of an optical sensor according to an embodiment of the invention. FIG. 2 shows a schematic diagram of an object image and background noise according to an embodiment of the invention. With reference to FIG. 1 and FIG. 2, the optical sensor 100 includes a sensing array 110, a sampling circuit 120 and an operational circuit 130. The sensing array 110 includes a plurality of sensing units arranged in an array, and is coupled to the sampling circuit 120. The sampling circuit 120 is coupled to the operational circuit 130. The operational circuit 130 includes an operational unit 131 and a delay unit 132. In the present embodiment, when the sensing array 110 performs an exposure operation, the sampling circuit 120 may obtain an object image 230 as shown in FIG. 2. The object image 230 includes noise and an object feature. When the sensing array 110 performs a reset operation, the sampling circuit 120 may obtain a background image 220 as shown in FIG. 2.

It is firstly noted that, as shown in FIG. 2, in a plurality of pixels of the object image 210 having no noise, a portion corresponding to the object feature has a higher pixel value (for example, a value of 10), and a portion not corresponding to the object feature has a lower pixel value without significant fluctuations (for example, a value of 0). However, since the plurality of sensing units of the sensing array 110 may respectively suffer from electromagnetic interference inside or outside the sensing units, when the sampling circuit 120 performs sampling on the plurality of sensing units of the sensing array 110, sensing values output by the sampling circuit 120 will be offset by noise. Generally, the background image may be regarded as noise, and a plurality of pixels of the background image may respectively have different pixel values with great differences and random changes (for example, the background image 220 in FIG. 2). In other words, when the sensing array 110 performs the exposure operation, the sampling circuit 120 will obtain a plurality of pixels, each of which has a pixel value corresponding to the noise and the object feature (for example, the object image 230 in FIG. 2). In this regard, the sampling circuit 120 of the present embodiment will perform sampling when the sensing array 110 performs the reset operation to obtain the background image 220 as shown in FIG. 2. Therefore, the operational circuit 130 may perform subtraction on the pixel value of each pixel of the object image 230 and the pixel value of each pixel of the object image 230 to obtain the object image 210 having no noise as shown in FIG. 2.

In the present embodiment, the optical sensor 100 may perform the exposure operation first such that the sensing array 110 senses the object, and the sampling circuit 120 performs sampling on the plurality of sensing units of the sensing array 110 to obtain a plurality of first sensing signals. The sampling circuit 120 may output a plurality of first pixel data of the object image to the operational circuit 130 according to the plurality of first sensing signals. In the present embodiment, the delay unit 132 of the operational circuit 130 may receive from the sampling circuit 120 first and delay output of the plurality of first pixel data (the pixel value of each pixel of the object image 230 as shown in FIG. 2). The plurality of first pixel data may each be represented by Equation (1) below. S(T, ta) represents a pixel value output by the sampling circuit 120 at a time point ta after the sensing units performs image integration for a time period T. B(ta) is a value offset generated by the electromagnetic interference inside or outside the sensing unit at the time point ta (i.e., the pixel value corresponding to the noise output by the sampling circuit 120 at the time point ta).

X(ta)=S(T,ta)+B(ta) Equation (1)

Next, the optical sensor 100 performs the reset operation, and during the reset process of the plurality of sensing units of the sensing array 110, the sampling circuit 120 performs sampling on the sensing array 110 to obtain a plurality of second sensing signals to the sampling circuit 120. The sampling circuit 120 may output a plurality of second pixel data to the operational circuit 130 according to the plurality of second sensing signals. The plurality of second pixel data may each be represented by Equation (2) below. Since T=0, S(T=0, ta) is 0 in the case of no image integration. B(tb) is a value offset generated by the electromagnetic interference inside or outside the sensing unit at a time point to (i.e., the pixel value corresponding to the noise output by the sampling circuit 120 at the time point tb).

X(tb)=S(T=0,tb)+B(tb) Equation (2)

In the present embodiment, the operational unit 131 of the operational circuit 130 receives the plurality of second pixel data (the pixel value of each pixel of the background image 220 as shown in FIG. 2) from the sampling circuit 120, and performs a subtraction operation shown as Equation (3) below on each of the plurality of first pixel data and the corresponding plurality of second pixel data according to the output of the delay unit 132 to obtain S(T,ta)+B(ta)−B(tb). In this regard, if the electromagnetic interference inside or outside the sensing unit is low-frequency interference, then B(ta)−B(tb) may be simulated as or equivalent to 0. Therefore, the operational circuit 130 may output a pixel value operation result of each pixel to generate the denoised object image 210 as shown in FIG. 2. In other words, the optical sensor 100 may have a good suppression effect on the low-frequency interference. Besides, since a time difference between the exposure operation and the reset operation is very short, the optical sensor 100 can also provide high filter efficiency without affecting the frame rate.

X(ta)−X(tb)=S(T,ta)+B(ta)−B(tb) Equation (3)

However, the execution order of the exposure operation and the reset operation of the invention is not limited to the above order. In an embodiment, the optical sensor 100 may also perform the reset operation first, so that the sensing array 110 senses the object and outputs the plurality of second sensing signals to the sampling circuit 120, and the sampling circuit 120 outputs the plurality of second pixel data to the operational circuit 130. Next, the optical sensor 100 performs the exposure operation, so that the sensing array 110 outputs the plurality of first sensing signals to the sampling circuit 120, and the sampling circuit 120 outputs the plurality of first pixel data to the operational circuit 130. Therefore, the delay unit 132 of the operational circuit 130 may receive from the sampling circuit 120 first and delay output of the plurality of second pixel data (the pixel value of each pixel of the background image 220 as shown in FIG. 2). Next, the operational unit 131 of the operational circuit 130 receives the plurality of first pixel data (the pixel value of each pixel of the object image 230 as shown in FIG. 2) from the sampling circuit 120, and performs the subtraction operation on the plurality of first pixel data and the plurality of second pixel data according to the output of the delay unit 132. Therefore, the operational circuit 130 may also output the pixel value operation result of each pixel to generate the denoised object image 210 as shown in FIG. 2.

In addition, the optical sensor 100 in the present embodiment may be a fingerprint sensor, so the object images 210, 230 may be fingerprint images, and the above object feature may be a fingerprint feature, but the invention is not limited thereto. In an embodiment, the optical sensor 100 may also be a palm print sensor, another biometric sensor, or an image sensor for any purpose.

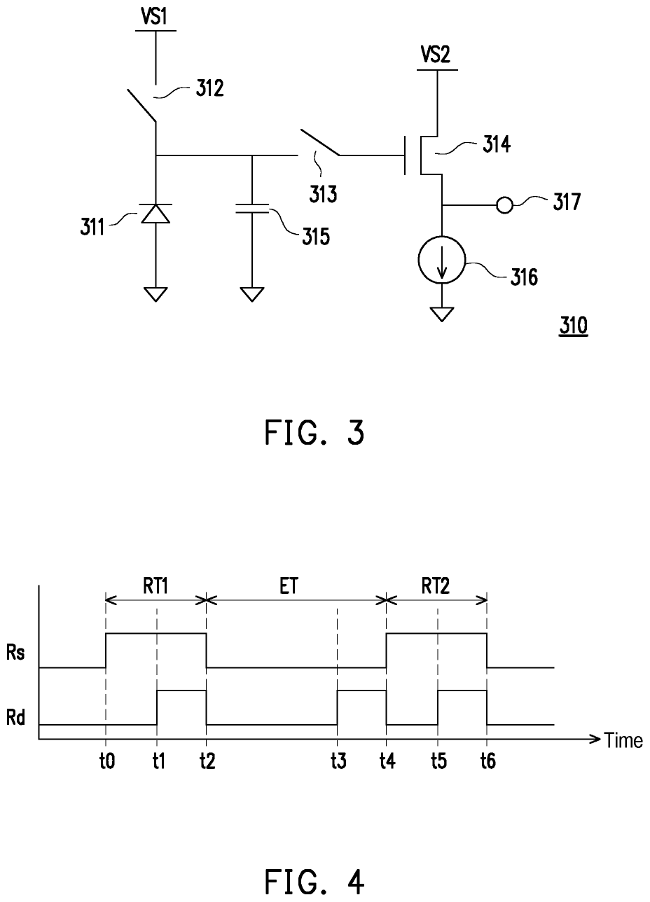

FIG. 3 shows a schematic diagram of an active pixel sensing unit according to an embodiment of the invention. FIG. 4 shows a timing diagram of an exposure operation and a reset operation according to an embodiment of the invention. With reference to FIG. 3 and FIG. 4, the sensing unit 310 shown in FIG. 3 is an active pixel sensor (APS), and is applicable to the sensing unit according to the embodiments of the invention. The sensing unit 310 includes a photodiode 311, a reset switch 312, a read switch 313, a transistor switch 314, a storage capacitor 315, a reference current 316, and a sensing output terminal 317. In the present embodiment, a first terminal of the photodiode 311 is grounded and configured to sense an object to generate a sensing current. A first terminal of the storage capacitor 315 is grounded, and a second terminal is coupled to a second terminal of the photodiode 311. When the photodiode 311 senses the object, the photodiode 311 performs photoelectric conversion to generate the sensing current, and charges the storage capacitor 315 such that the storage capacitor 315 stores a charge corresponding to the sensing current. A first terminal of the reset switch 312 is coupled to the photodiode 311 and the storage capacitor 315 and configured to reset the storage capacitor 315. A second terminal of the reset switch 312 is coupled to a reference voltage VS1. A first terminal of the read switch 313 is coupled to the storage capacitor 315, and a second terminal is coupled to a control terminal of the transistor switch 314. A first terminal of the transistor switch 314 is coupled to the reference current 316 and the sensing output terminal 317, and a second terminal of the transistor switch 314 is coupled to a reference voltage VS2. The sensing output terminal 317 is coupled to the sampling circuit 120 shown in FIG. 1.

FIG. 4 shows a switching timing Rs of the reset switch 312 and a switching timing Rd of the read switch 313, which will be described in conjunction with FIG. 3. In an embodiment, before an exposure operation ET of a current frame, the sensing unit 310 performs a reset operation RT1 during a period from a time point t0 to a time point t2. After the sensing unit 310 performs the exposure operation ET, it performs a reset operation RT2 next for a next frame starting from a time point t4. In this regard, in the exposure operation ET, the reset switch 312 is off during a period from the time point t2 to the time point t4, and the storage capacitor 315 receives the sensing current from the photodiode 311 to perform image integration. After the storage capacitor 315 completes the integration at a time point t3, the read switch 313 will be turned on, so that the transistor switch 314 will be turned on accordingly. Therefore, the sensing output terminal 317 may correspondingly output the first sensing signal to the sampling circuit 120. It is worth noting that a magnitude of the first sensing signal is determined by a magnitude of a voltage provided by the storage capacitor 315 to the control terminal of the transistor switch 314 and the reference voltage VS2, and the first sensing signal includes object image information and noise.

Next, in the reset operations RT1, RT2 respectively, the reset switch 312 will be continuously turned on during the period from the time point t0 to the time point t2 and the period from the time point t4 to a time point t6, so that the storage capacitor 315 remains reset. The read switch 313 may be turned on at any time point in the reset operations RT1, RT2 (for example, a time point t1 and a time point t5 shown in FIG. 4), so that the transistor switch 314 is turned on. Therefore, the sensing output terminal 317 may correspondingly output the second sensing signal to the sampling circuit 120. It is worth noting that a magnitude of the second sensing signal is determined by the magnitude of the voltage provided by the storage capacitor 315 to the control terminal of the transistor switch 314 and the reference voltage VS2, and the second sensing signal includes only noise.

In other words, the sensing unit 310 may choose to output the second sensing signal to the sampling circuit 120 during a period from the time point t1 to the time point t2 of the reset operation RT1 of the current frame, and then output the first sensing signal to the sampling circuit 120 during a period from the time point t3 to the time point t4 of the exposure operation ET of the current frame, so that the operational circuit 130 of FIG. 1 may receive the second pixel data provided by the sampling circuit 120 first and then the first pixel data provided by the sampling circuit 120, and perform a subtraction operation on the two. Alternatively, the sensing unit 310 may choose to output the first sensing signal to the sampling circuit 120 during the period from the time point t3 to the time point t4 of the exposure operation ET of the current frame, and then output the second sensing signal to the sampling circuit 120 during a period from the time point t5 to the time point t6 of the reset operation RT2 of the next frame, so that the operational circuit 130 of FIG. 1 may receive the first pixel data provided by the sampling circuit 120 first and then the second pixel data provided by the sampling circuit 120, and perform a subtraction operation on the two.

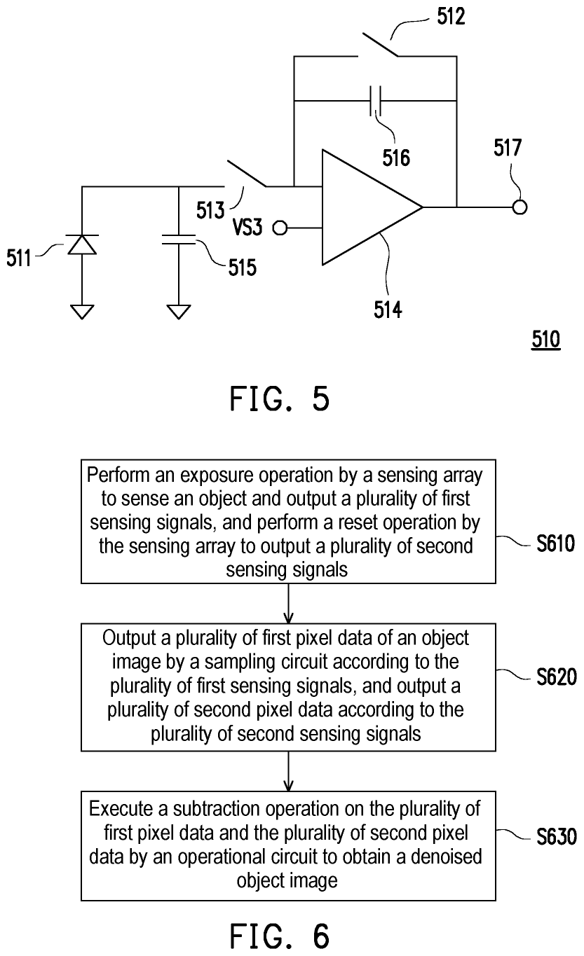

FIG. 5 shows a schematic diagram of a passive pixel sensing unit according to an embodiment of the invention. With reference to FIG. 4 and FIG. 5, the sensing unit 510 shown in FIG. 5 is a passive pixel sensor (PPS), and is applicable to the sensing unit according to the embodiments of the invention. The sensing unit 510 includes a photodiode 511, a reset switch 512, a read switch 513, a comparator 514, a storage capacitor 515, a reset capacitor 516, and an output terminal 517. In the present embodiment, a first terminal of the photodiode 511 is grounded and configured to sense an object to generate a sensing current. A first terminal of the storage capacitor 515 is grounded, and a second terminal is coupled to a second terminal of the photodiode 511. The storage capacitor 515 is configured to store the sensing current provided by the photodiode 511. A first terminal of the read switch 513 is coupled to the second terminal of the storage capacitor 515, and a second terminal of the read switch 513 is coupled to a first input terminal of the comparator 514. A second input terminal of the comparator 514 is coupled to a reference voltage VS3. A first terminal of the reset switch 512 and a first terminal of the reset capacitor 516 are coupled to a first input terminal of the comparator 514, and a second terminal of the reset switch 512 and a second terminal of the reset capacitor 516 are coupled to an output terminal of the comparator 514. The output terminal of the comparator 514 is coupled to the sensing output terminal 517. The sensing output terminal 517 may be coupled to the sampling circuit 120 as shown in FIG. 1. When the reset switch 512 is turned on and the read switch 513 is turned on, the reset switch 512 is configured to reset the storage capacitor 515.

It can be understood that the reset switch 512 may operate the switching timing Rs as shown in FIG. 4, and the read switch 513 may operate the switching timing Rd as shown in FIG. 4. In an embodiment, before an exposure operation ET in a current frame, the sensing unit 510 performs a reset operation RT1 during a period from a time point t0 to a time point t2. After the sensing unit 510 performs the exposure operation ET, it performs a reset operation RT2 next for a next frame starting from a time point t4. In this regard, in the exposure operation ET, the reset switch 512 is off during a period from the time point t2 to the time point t4, and the storage capacitor 515 receives the sensing current of the photodiode 511 to perform image integration. After the storage capacitor 515 completes the integration at a time point t3, the read switch 513 will be turned on, so that the comparator 514 may correspondingly output the first sensing signal to the sampling circuit 120 through the sensing output terminal 517. It is worth noting that a magnitude of the first sensing signal is determined by a magnitude of a voltage provided by the storage capacitor 515 to the first input terminal of the comparator 514, and the first sensing signal includes object image information and noise.

Next, in the reset operations RT1, RT2 respectively, the reset switch 512 will be continuously turned on during the period from the time point t0 to the time point t2 and the period from the time point t4 to a time point t6. Besides, the read switch 513 may be turned on at any time point in the reset operations RT1, RT2 (for example, a time point t1 and a time point t5 shown in FIG. 4), so that the storage capacitor 515 is reset. Therefore, the comparator 514 may correspondingly output the second sensing signal to the sampling circuit 120 through the sensing output terminal 517. It is worth noting that a magnitude of the second sensing signal is determined by a magnitude of a voltage provided by the storage capacitor 515 to the first input terminal of the comparator 514, and the second sensing signal includes only noise.

In other words, the sensing unit 510 may choose to output the second sensing signal to the sampling circuit 120 during a period from the time point t1 to the time point t2 of the reset operation RT1 of the current frame, and then output the first sensing signal to the sampling circuit 120 during a period from the time point t3 to the time point t4 of the exposure operation ET of the current frame, so that the operational circuit 130 of FIG. 1 may receive the second pixel data provided by the sampling circuit 120 first and then the first pixel data provided by the sampling circuit 120, and perform a subtraction operation on the two. Alternatively, the sensing unit 510 may choose to output the first sensing signal to the sampling circuit 120 during the period from the time point t3 to the time point t4 of the exposure operation ET of the current frame, and then output the second sensing signal to the sampling circuit 120 during a period from the time point t5 to the time point t6 of the reset operation RT2 of the next frame, so that the operational circuit 130 of FIG. 1 may receive the first pixel data provided by the sampling circuit 120 first and then the second pixel data provided by the sampling circuit 120, and perform a subtraction operation on the two.

FIG. 6 shows a flow chart of an image sensing method according to an embodiment of the invention. With reference to FIG. 1 and FIG. 6 at the same time, the image sensing method of the present embodiment may be adapted for at least the optical sensor 100 of FIG. 1. In step S610, a sensing array 110 performs an exposure operation to sense an object and output a plurality of first sensing signals, and the sensing array 110 performs a reset operation to output a plurality of second sensing signals. In step S620, a sampling circuit 120 outputs a plurality of first pixel data of an object image according to the plurality of first sensing signals, and outputs a plurality of second pixel data according to the plurality of second sensing signals. In step S630, an operational circuit 130 executes a subtraction operation on the plurality of first pixel data and the plurality of second pixel data to obtain a denoised object image. Therefore, the image sensing method of the present embodiment can enable the optical sensor 100 to provide a denoised object image with a good image quality effect.

In summary, according to the optical sensor and the image sensing method of the invention, the subtraction operation may be performed by the sampling circuit on the plurality of first pixel data and the plurality of second pixel data provided by the sensing array respectively in the exposure operation and the reset operation executed successively to quickly obtain the plurality of denoised pixel data, so that the denoised object image can be formed. Therefore, the optical sensor and the image sensing method of the invention can have a good suppression effect on the low-frequency interference, and can perform denoising work of the object image inside the optical sensor in real time without affecting the frame rate.

Finally, it should be noted that the foregoing embodiments are merely used for describing the technical solutions of the invention, but are not intended to limit the invention. Although the invention is described in detail with reference to the foregoing embodiments, a person of ordinary skill in the art should understand that, modifications may still be made to the technical solutions in the foregoing embodiments, or equivalent replacements may be made to some or all of the technical features; and such modifications or replacements will not cause the essence of corresponding technical solutions to depart from the scope of the technical solutions in the embodiments of the invention.

What is claimed is:

1. An optical sensor, comprising:
a sensing array, performing an exposure operation to sense an object and output a plurality of first sensing signals, and performing a reset operation to output a plurality of second sensing signals;
a sampling circuit, coupled to the sensing array, outputting a plurality of first pixel data of an object image according to the plurality of first sensing signals, and outputting a plurality of second pixel data according to the plurality of second sensing signals; and
an operational circuit, coupled to the sampling circuit, and executing a subtraction operation on the plurality of first pixel data and the plurality of second pixel data to obtain a denoised object image.

2. The optical sensor according to claim 1, wherein the sampling circuit outputs the plurality of first sensing signals first, and then outputs the plurality of second sensing signals.

3. The optical sensor according to claim 1, wherein the sampling circuit outputs the plurality of second sensing signals first, and then outputs the plurality of first sensing signals.

4. The optical sensor according to claim 1, wherein the operational circuit comprises:
a delay unit, coupled to the sampling circuit, and receiving and delaying output of one of the first pixel data and the second pixel data from the sampling circuit; and
an operational unit, coupled to the sampling circuit and the delay unit, receiving the other of the first pixel data and the second pixel data from the sampling circuit, and performing subtraction on the first pixel data and the second pixel data according to the output of the delay unit to obtain the denoised object image.

5. The optical sensor according to claim 1, wherein the sensing array comprises a plurality of sensing units arranged in an array, and the plurality of sensing units each comprise:
a photodiode, sensing the object to generate a sensing current;
a storage capacitor, coupled to the photodiode, the photodiode charging the storage capacitor through the sensing current such that the storage capacitor stores charges corresponding to the sensing current;
a read switch, coupled to the storage capacitor and the sampling circuit; and
a reset switch, coupled to the storage capacitor,
wherein in the exposure operation, the reset switch is off, and the read switch is turned on to output the first sensing signal according to a magnitude of a voltage provided by the storage capacitor after energy storage,
wherein in the reset operation, the reset switch is turned on to discharge the storage capacitor, and the read switch is turned on to output the second sensing signal.

6. The optical sensor according to claim 1, wherein the optical sensor is a fingerprint sensor, and the denoised object image is a fingerprint image.

7. An image sensing method adapted for an optical sensor, the optical sensor comprising a sensing array, a sampling circuit, and an operational circuit, wherein the image sensing method comprises:
performing an exposure operation by the sensing array to sense an object and output a plurality of first sensing signals, and performing a reset operation by the sensing array to output a plurality of second sensing signals;
outputting, by the sampling circuit, a plurality of first pixel data of an object image according to the plurality of first sensing signals, and outputting a plurality of second pixel data according to the plurality of second sensing signals; and
executing a subtraction operation on the plurality of first pixel data and the plurality of second pixel data by the operational circuit to obtain a denoised object image.

8. The image sensing method according to claim 7, wherein the sampling circuit outputs the plurality of first sensing signals first, and then outputs the plurality of second sensing signals.

9. The image sensing method according to claim 7, wherein the sampling circuit outputs the plurality of second sensing signals first, and then outputs the plurality of first sensing signals.

10. The image sensing method according to claim 7, wherein the step of executing the subtraction operation on the plurality of first pixel data and the plurality of second pixel data to obtain the denoised object image comprises:
receiving and delaying output of one of the first pixel data and the second pixel data by a delay unit; and
receiving, by an operational unit, the other of the first pixel data and the second pixel data from the sampling circuit, and performing subtraction on the first pixel data and the second pixel data according to the output of the delay unit to obtain the denoised object image.

11. The image sensing method according to claim 7, wherein the sensing array comprises a plurality of sensing units arranged in an array, and the plurality of sensing units each comprise a photodiode, a storage capacitor, a read switch and a reset switch, wherein the exposure operation comprises:
not turning on the reset switch, and turning on the read switch to output the first sensing signal according to a magnitude of a voltage provided by the storage capacitor after energy storage,
wherein the reset operation comprises:
turning on the reset switch to discharge the storage capacitor, and turning on the read switch to output the second sensing signal.

12. The image sensing method according to claim 7, wherein the optical sensor is a fingerprint sensor, and the denoised object image is a fingerprint image.
